(19) United States
(12) Patent Application Publication
(10) Pub. No.: US 2004/0069484 A1
(43) Pub. Date: Apr. 15, 2004

(54) Vehicle air conditioner with rotary switching door

(76) Inventors: Takahiro Tokunaga, Kosai-city (JP); Takuya Natsume, Kariya-city (JP)

Correspondence Address: HARNESS, DICKEY & PIERCE, P.L.C., P.O. BOX 828, BLOOMFIELD HILLS, MI, 48303, US

(21) Appl. No.: 10/682,470

(22) Filed: Oct. 9, 2003

(30) Foreign Application Priority Data
Oct. 11, 2002 (JP) 2002-298755

(51) Int. Cl. G05D 23/13; B60H 3/00; B61D 27/00; F25D 17/04; B60H 1/00; B60H 1/32

(52) U.S. Cl. 165/204; 236/12.18; 165/42; 62/186; 62/244

(57) ABSTRACT

A vehicle air conditioner has an air conditioning case in which a rotary door is provided in an intersection between a cooled and a heated air passage, and a face and a foot blow-out opening. The communicating area ratio(s) between an inlet-side opening of the rotary door and the cooled air passage, the heated air passage, or both the cooled and heated air passages can change by rotating the rotary door, so that the rotary door serves as an air-mix door. In addition, the communicating area ratio(s) between an outlet-side opening and the face opening, the foot opening, or both the face and foot openings can change, so that the rotary door serves as a mode switching door. The conditioned air can be prevented from being blown out through the face and foot openings by rotating the rotary door to a predetermined position.

### CROSS REFERENCE TO RELATED APPLICATION

This application is based upon Japanese Patent Application No. 2002-298755, filed on Oct. 11, 2002, the contents of which are incorporated herein by reference.

### BACKGROUND OF THE INVENTION

1. Field of the Invention

The present invention relates to a vehicle air conditioner, which has a rotary door for switching a blow-out mode.

2. Related Art

An air conditioner such as the one disclosed in JP-A-2001-138728, which is matured to a U.S. Pat. No. 6,463,998, has rear seat air conditioning as well as front seat air conditioning. The air conditionings can be independently controlled from one another so that a blow-out mode and/or a blow-out temperature can be independently adjusted.

In the air conditioning apparatus disclosed in the above-described Japanese patent application publication, a single heating heat exchanger is provided for both of the front and rear seat air conditionings. However, the air conditioning apparatus disclosed in the publication has an air-mix door to control the mix ratio between the heated air and the cooled air, a rear seat face door to open/close a rear seat face blow-out port, and a rear seat foot door to open/close a rear seat foot blow-out port. Therefore, three doors are required to control the air conditionings. The rear seat face and foot doors are operated by single driving means to switch the blow-out mode. The blow-out mode has a face mode to blow out the conditioned air around a rear seat passenger's head, a foot mode to blow out the conditioned air around a rear seat passenger's foot, a bi-level mode to blow out the conditioned air from both of the rear seat face and foot blow-out ports, and a shut mode to shut both blow-out ports.

Another air conditioning apparatus, disclosed in JP-A-H05-58143, has a rotary door at the air mixing zone in a air conditioning case where the cooled air as well as the heated air come in to be mixed together. Plural blow-out ports are arranged in a downstream side of the rotary door, so that the rotary door serves as an air mix door to adjust the mixing ratio between the cooled air and the heated air, and a mode switching door to switch the blow-out mode.

The rotary door disclosed has a cylindrical shape having two openings at its circumference. The cooled and heated air come in the air mixing zone through the two openings, and further, the mixed air flows out from the air mixing zone through at least one of the openings. Therefore, the blow-out loss is large when using this rotary door. Moreover, this rotary door cannot shut both of the face and foot blow-out ports.

It is desired that a shut mode is provided so that both of the face and foot blow-out ports are shut while the blow-out amount of the conditioned air is increased to enhance an ability to prevent a windshield from being fogged when a blow-out mode of a front seat side is set in a defroster mode. It is further desired that the conditioned air is stopped from being supplied to a rear seat side by shutting the rear seat blow-out ports when no passenger sits on a rear seat.

### SUMMARY OF THE INVENTION

An object of the invention is to provide an improved vehicle air conditioning apparatus with a rotary door.

According to an aspect of the present invention, the air conditioning apparatus has a cooled air passage and a heated air passage. The air conditioning apparatus has an air mixing zone to which the cooled air passage and the heated air passage are connected so that the cooled air is mixed with the heated air. The air conditioning apparatus further comprises plural blow-out openings each of which is connected to the air mixing zone so that the conditioned air can flow through each blow-out opening. A rotary door having a circumferential wall is provided at the air mixing zone. The rotary door has plural openings to define a partition wall formed between adjacent openings. The rotary door can be rotated in order to adjust an opening area between the cooled air passage and the air mixing zone and an opening area between the heated air passage and the air mixing zone, so that the amount of the cooled air coming into the air mixing zone through the cooled air passage and the amount of the heated air coming into the air mixing zone through the heated air passage are adjustable. Moreover, an opening area formed between an outlet-side opening of the rotary door and one of the blow-out openings and an opening area formed between the outlet-side opening of the rotary door and a different one of the blow-out openings are adjusted so that the amount of the conditioned air flowing out from the air mixing zone through the one of the blow-out openings and the amount of the conditioned air flowing out from the air mixing zone through the different one of the blow-out openings are adjustable. Furthermore, the rotary door has a position where the plural blow-out openings are closed by the partition wall thereof.

Further areas of applicability of the present invention will become apparent from the following detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross sectional view of an air conditioning unit in a vehicle air conditioning apparatus of a first embodiment of the present invention;

FIG. 2 is an enlarged cross sectional view of the air conditioning unit illustrating a portion of a unit case including a rotary door of the first embodiment of the present invention;

FIGS. 3A to 3F show an enlarged cross sectional view illustrating a position of the rotary door in a predetermined blow-out mode, respectively, and FIG. 3G is a graph showing relationship between temperature and a blow-out mode or face, bi-level, foot, and shut mode in the first embodiment of the present invention;

FIG. 4 is an enlarged cross sectional view of an air conditioning unit illustrating a portion of a unit case including a rotary door of a second embodiment of the present invention;

FIG. 5 is a perspective view illustrating a blow-out portion for a rear seat side of a third or fourth embodiment of the present invention;

FIG. 6A is an enlarged cross sectional view of an air conditioning unit illustrating a portion, designated by an arrow A shown in FIG. 5, of a unit case including a rotary door of the third embodiment of the present invention;

FIG. 6B is an enlarged cross sectional view of the air conditioning unit illustrating a portion, designated by an arrow B shown in FIG. 5, of the unit case including the rotary door of the third embodiment of the present invention;

FIG. 7A is an enlarged cross sectional view of an air conditioning unit illustrating a portion, designated by an arrow A shown in FIG. 5, of a unit case including a rotary door of the fourth embodiment of the present invention, and FIG. 7B is an enlarged cross sectional view of the air conditioning unit illustrating a portion, designated by an arrow B shown in FIG. 5, of the unit case including the rotary door of the fourth embodiment of the present invention.

### DETAILED DESCRIPTION OF THE PREFERRED EMBODIMENT

Specific embodiments of the present invention will now be described hereinafter with reference to the accompanying drawings in which the same or similar component parts are designated by the same or similar reference numerals.

(First Embodiment)

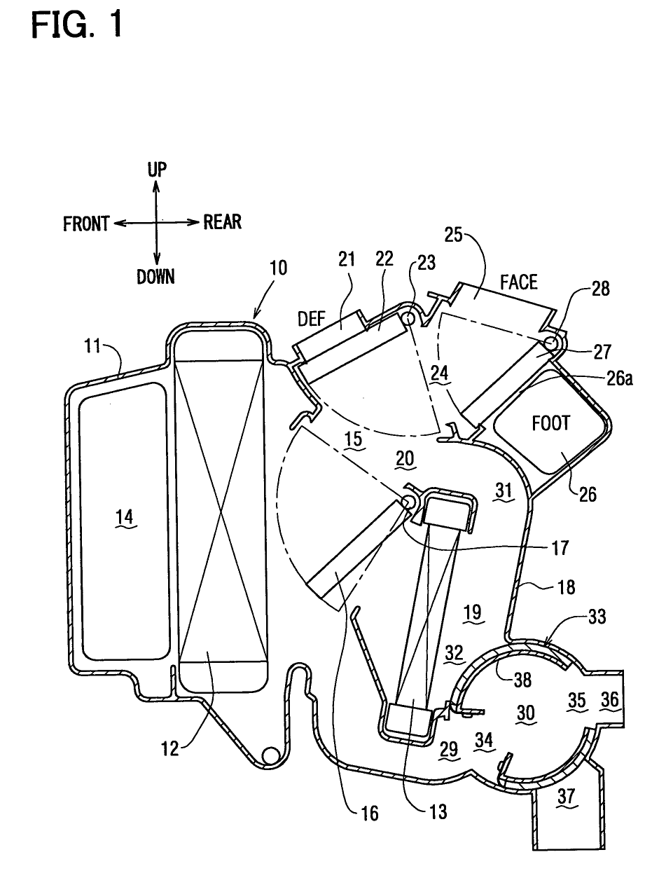

First, a schematic ventilation system of a vehicle will be described with reference to FIG. 1. An air conditioning apparatus generally has an air blowing unit (not shown) and an air conditioning unit 10. The air blowing unit is disposed at a position under an instrumental panel inside the vehicle, and a position relatively shifted to a passenger seat side from a center. The air conditioning unit 10 is disposed at a position under the instrumental panel inside the vehicle, and a position approximate to a center in a lateral direction of the vehicle.

As well known, the air blowing unit has an inside/outside air switching box which introduces the air inside the unit by switching between the air of the outside of the vehicle and the air of the passenger compartment, and a blower unit to suck the air from the inside/outside air switching box and blow out the air to the air conditioning unit 10. The air conditioning unit 10 includes an air conditioning case 11, an evaporator (cooling heat exchanger) 12 and a heater core (heating heat exchanger) 13 both of which are integrally contained in the air conditioning case 11. The air conditioning unit 10 may be made of resin having a certain amount of elasticity and excellent in strength such as polypropylene.

The air conditioning case 11 is composed of plural separated cases. After containing the heat exchangers 12, 13 and doors or the like (described later) therein, the separated cases are integrally united as the unit 10 by way of a fastening device such as a metal spring clip, a screw or the like. The air conditioning unit 10 is disposed in a predetermined orientation of a front-rear direction and an up-down (vertical) direction of the vehicle as shown in FIG. 1. An air inlet 14 is formed at a side of a most-front side of the air conditioning case 11. The air blown by the blower unit comes into the air inlet 14.

The evaporator 12 is arranged just behind the air inlet 14 in the case 11 in the up-down direction so that an air passage in the case 11 is crossed with its thin portion. As well known, the evaporator 12 cools down the air coming therein from the air inlet 14 by absorbing heat from the air as latent heat for evaporation of coolant in a refrigerant cycle.

The heater core 13 is arranged in a downstream side (a rear side of the vehicle) of the evaporator with a predetermined gap interposed therebetween. The heater core 13 is disposed in an inclined arrangement at a lower side of the air conditioning case 11. A dimension of width of the evaporator 12 and the heater core 13 is approximately equal to that of the air conditioning case 11.

The heater core 13 has hot water (cooling water) therein flowing in the engine as a heat source to heat the cooled air cooled at the evaporator 12. A cooled air bypass passage 15 for front seat is formed at an upper side of the heater core 13 so that the cooled air can bypass the heater core 13.

A front side air mix door 16 for front seat (a front seat temperature adjusting means) is arranged between the heater core 13 and the evaporator 12. The front side air mix door 16 has a plate-like configuration. The front side air mix door 16 opens/closes the cooled air bypass passage 15, and adjust the amount of the cooled air bypassing the heater core 13 and flowing through the cooled air bypass passage 15.

The front side air mix door 16 is fixed to a rotating shaft 17 disposed in a horizontal direction (a width direction of vehicle) so as to be able to pivotally rotate with respect to the rotating shaft 17 in the vertical direction of the vehicle. The rotating shaft 17 is pivotally supported by the air conditioning case 11. The rotating shaft 17 protrudes from the air conditioning case 11 to be connected through a link mechanism (not shown) to an actuator such as a servo motor (not shown). A rotated position of the front side air mix door 16 is adjusted by the actuator.

A wall portion 18 is formed so as to extend approximately in the vertical direction of the vehicle, and arranged in the air conditioning case 11 at a downstream side of air (a rear side of the vehicle) with respect to the heater core 13 to have a gap interposed therebetween. The gap between the heater core 13 and the wall portion 18 is a heated air passage 19 extending approximately in the vertical direction of the vehicle. An upper portion of the heated air passage 19 is a front side heated air passage 31 for front seat, and a lower portion of the heated air passage 19 is a rear side heated air passage 32 for rear seat.

The front side heated air passage 31 merges with a downstream-side portion of the front side cooled air passage 15 to form an air mixing portion 20 for front seat to mix the cooled air and heated air.

A defroster opening 21 is formed in a portion relatively close to the front of the vehicle at a top of the air conditioning case 11, which the conditioned air controlled in temperature at the air mixing portion 20 comes into. The defroster opening 21 is connected to a defroster blow-out port (not shown) through a defroster duct (not shown). The conditioned air is blown toward an inside plane of a windshield of the vehicle through the defroster blow-out port.

The defroster opening 21 can be opened/closed by a plate-like defroster door 22. The defroster door 21 is rotated by a rotating shaft 23 disposed in the horizontal direction at a proximity of the top of the air conditioning case 11. The defroster door 22 opens/closes the defroster opening 22 and a communicating passage 24 so that the defroster opening 21 is closed while the communicating passage 24 is opened, vise versa. The communicating passage 24 is a passage for supplying the conditioned air conditioned at the air mixing portion 20 to a face opening 25 for front seat (described below) and a foot opening 26 for front seat (described below).

The front seat face opening 25 is provided at a portion relatively close to the rear of the vehicle (passenger side) with respect to the defroster opening 21. The face opening 25 is connected to a front seat face blow-out port arranged at an upper side of the instrumental panel through a front seat face duct (all of them are not shown) to blow out the conditioned air toward an upper body of a passenger.

The front seat foot opening 26 is provided at a lower side with respect to the front seat face opening 25. The foot opening 26 is opened at both sides of the case 11 in the lateral direction of the case 11 (not shown) to blow out the conditioned air toward feet of passengers at a driver side and an assistant driver side through front seat foot blow-out ports (not shown), respectively.

A face/foot switching door 27 is rotatably provided by a rotating shaft 28 between the both openings 25 and 26 to open/close the face opening 25 and an inlet portion 26a of the foot opening 26, so that the face opening 25 is closed while the inlet portion 26a of the foot opening 26 is opened, vise versa.

The defroster door 22 and the face/foot switching door 27 are front seat blow-out mode switching means. The rotating shafts 23 and 28 are connected to a blow-out mode switching actuator such as servo motor (not shown) through linkage (not shown), so that the doors 22 and 27 are operated by the actuator.

Next, the main feature of the present invention will be described. A cooled air bypass passage 29 for rear seat is formed at a lower side of the heater core 13 in the air conditioning case 11 to let the cooled air from the evaporator 12 bypass and flow therein. A rotary door 33 is disposed in an intersection part (air mixing zone) 30 between the rear seat heated air passage 32 and the rear seat cooled air bypass passage 29.

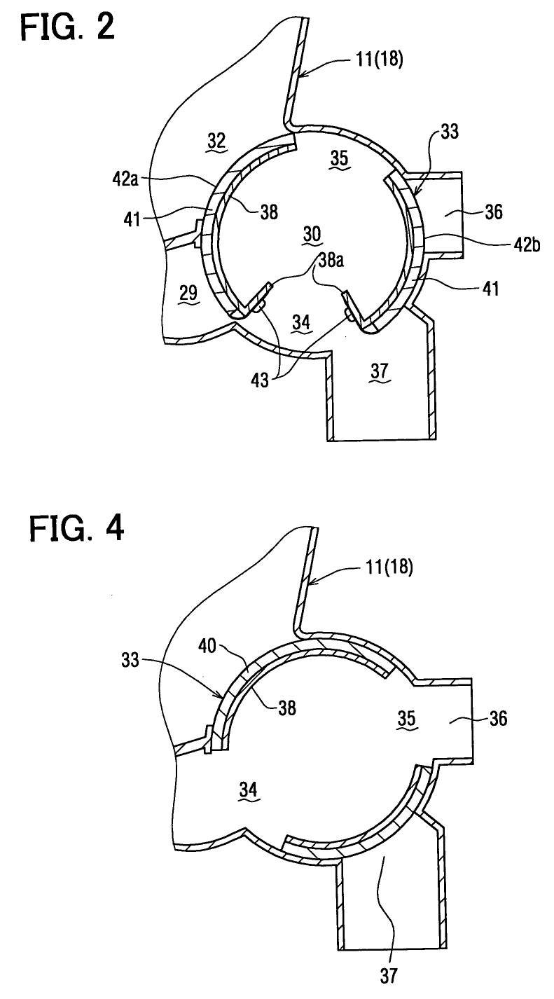

Referring to FIG. 2, a shut mode is shown, which is described later. The rotary door 33 has a cylindrical shape, and plural openings 34 and 35 at its circumference and partition walls 42a (a longer circular arc) and 42b (a shorter circular arc) in this embodiment. The partition walls 42a and 42b have two end portions, respectively. One end portion of the partition wall 42a and one end portion of the partition wall 42b define the opening 34, and the other of partition wall 42a and the other of the partition wall 42b define the opening 35 in this embodiment. A frame body of the rotary door 33 is made of metal member or resin member. Outer surface of the frame body 38 at the partition walls 42a, 42b is coated with a film member made of resin or attached with a thin plate member made of resin or metal.

The film member made of resin is, for example, a resin film or the like employed as a film door. The thin plate member made of resin or metal is, for example, a resin sheet or a metal sheet or the like employed as a flexible door. The film member or plate member is processed to have openings, and then, the member is attached to the flame body 38. The end portions of the member exposed to the opening are fixed to fixing portions 38a with fixing members 43. A packing 41 is attached to the flame body so as to be disposed on the film or plate member to softly support the member.

A rotating shaft of the rotary door 33 is rotatably supported by the air conditioning case 11. One end of the rotating shaft of the rotary door 33 protrudes from the air conditioning case 11 to be connected through a link mechanism (not shown) to an actuator such as a servo motor (not shown) in order to be activated.

A face opening 36 for rear seat and a foot opening 37 for rear seat are provided at a downstream side of the intersection part 30. The face opening 36 communicates with a rear seat face blow-out port through a rear seat face duct (all of them are not shown) to blow out the conditioned air toward an upper body of a passenger sitting on a rear seat. The foot opening 37 communicates with a rear seat foot blow-out port through a rear seat foot duct (all of them are not shown) to blow out the conditioned air toward a foot portion of the passenger sitting on a rear seat.

An angle posture of the rotary door 33 changes by rotation along a circumference direction, so that one of the openings 34 and 35, for example, the opening 34 (inlet-side opening) comes to make a communication with the cooled air bypass passage 29 and/or the heated air passage 32. In one situation, the ratio of the communicating area between the opening 34 and the cooled air bypass passage 29 can change while the heated air passage 32 is fully shut by the partition wall 42a or 42b. In one situation, the ratio of the communicating area between the opening 34 and the cooled air bypass passage 29 increases while the ratio of the communicating area between the opening 34 and the heated air passage 32 decreases, vice versa. Namely, the ratio of communicating areas can be simultaneously changed at both of the cooled air bypass passage 29 and the heated air passage 32. In one situation, the ratio of the communicating area between the opening 34 and the heated air passage 32 can change while the cooled air bypass passage 29 is fully shut by the partition wall 42a or 42b. With these situations, the mixing ratio between the cooled air and the heated air can change so that the temperature of the blow-out air into the passenger compartment is adjusted. Namely, the rotary door 33 has an air mixing function. The inside of the rotary door 33 serves as an air-mixing chamber to mix the cooled air from the cooled air bypass passage 29 and the heated air from the heated air passage 32 to produce the air having the desired temperature.

Meanwhile, the opening 35 (outlet-side opening) comes to make a communication with the face opening 36 and/or the foot opening 37. In one situation, the ratio of the communicating area between the opening 35 and the face opening 36 can change while the foot opening 37 is fully shut by the partition wall 42a or 42b. In one situation, the ratio of the communicating area between the opening 35 and the face opening 36 increases while the ratio of the communicating area between the opening 35 and the foot opening 37 decreases, vice versa. Namely, the ratio of communicating areas can be simultaneously changed at both of the face opening 36 and the foot opening 37. In one situation, the ratio of the communicating area between the opening 35 and the foot opening 37 can change while the face opening 36 is fully shut by the partition wall 42a or 42b. Therefore, the rotary door 33 serves as a mode switching door so that the mixed air inside the rotary door 33 can flow out from the rotary door 33 through the face opening 36, the foot opening 37, or both of them at the same time. Furthermore, the partition wall 42a can serve as a shut door to shut both of the face opening 36 and foot opening 37.

Above-described mechanism for air conditioning is controlled by a electronic control unit for air conditioner (ECU, not shown) The ECU has a micro-computer and the like to control the blower unit and the air conditioning unit 10 in accordance with pre-set programs. The ECU receives the power supply from a battery on the vehicle when an ignition switch (not shown) is turned on.

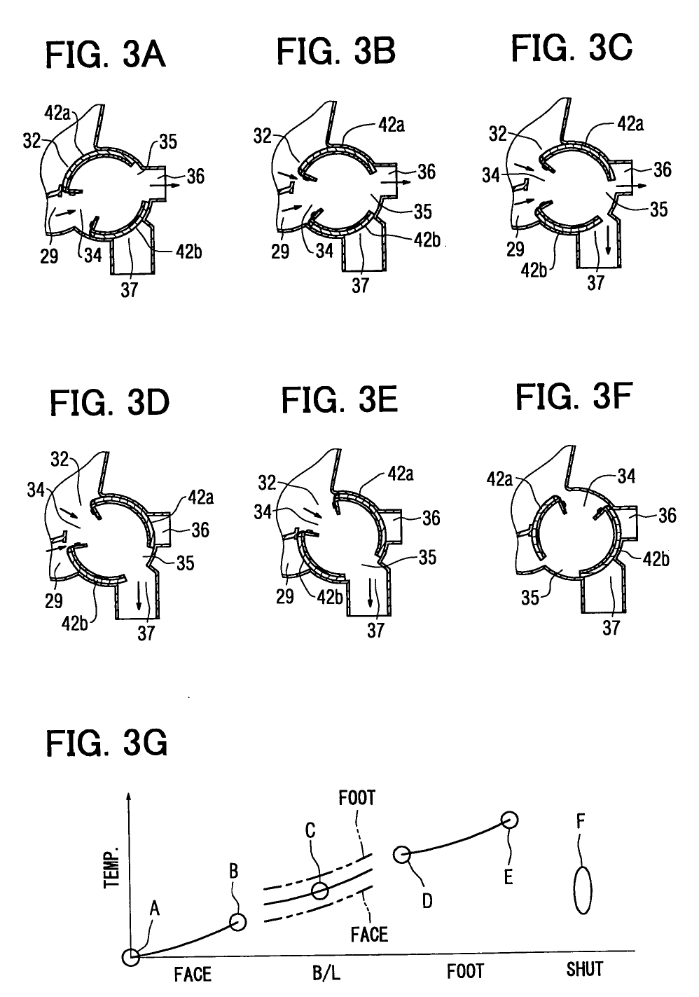

Next, an operation of the rotary door 33 will be described with reference to FIGS. 3A to 3F. The following modes can be set by rotating the rotary door 33. A graph shown in FIG. 3G shows the relationship between the following modes and temperature.

(1) Face Mode

When a face mode is selected based on a signal from a rear seat blow-out mode setting device (not shown) or based on the calculation result of the blow-out mode in the ECU, the rotary door 33 takes its position at between that shown in FIG. 3A and that shown in FIG. 3B. The position shown in FIG. 3A means the maximum cool with the cooled air bypass passage 29 fully opened by arranging the inlet-side opening 34 to fully communicate with the cooled air bypass passage 29 while the face opening 36 is fully opened by arranging the outlet-side opening 35 to fully communicate with the face opening 36. At this time, the heated air passage 32 and the foot opening 37 are closed by the partition wall 42a and the partition wall 42b, respectively. Therefore, the full amount of the cooled air from the cooled air bypass passage 29 is blown out through the face opening 36.

The position shown in FIG. 3B means that the inlet-side opening 34 fully opens the cooled air bypass passage 29 and partially opens the heated air passage 32. The outlet-side opening 35 fully opens the face opening 36 while the foot opening 37 is closed by the partition wall 42b. Therefore, a little bit amount of the heated air from the passage 32 is mixed with the cooled air from the bypass passage 29 to produce the mixed air having the temperature slightly higher than that of the cooled air from the bypass passage 29. The mixed air is blown out through the face opening 36.

(2) Bi-Level Mode

A bi-level mode is often used in a term between spring and autumn. When the bi-level mode is selected based on a signal from the rear seat blow-out mode setting device (not shown) or based on the calculation result of the blow-out mode in the ECU, the rotary door 33 takes its position shown in FIG. 3C. In this position, the inlet-side opening 34 almost equally opens the cooled air bypass passage 29 and the heated air passage 32. Also, the outlet-side opening 35 opens almost equally the face opening 36 and the foot opening 37.

Therefore, the mixed air having the desired temperature, obtained by mixing the cooled air from the bypass passage 29 and the heated air from the passage 32, simultaneously blown out through the face opening 36 and the foot opening 37 to an upper and a lower of a rear-seat side in the cabin. The desired temperature can be adjusted by changing the ratio between the cooled air and the heated air.

(3) Foot Mode

When a foot mode is selected based on a signal from a rear seat blow-out mode setting device (not shown) or based on the calculation result of the blow-out mode in the ECU, the rotary door 33 takes its position at between that shown in FIG. 3D and that shown in FIG. 3E. The position shown in FIG. 3E means the maximum heat with the heated air passage 32 fully opened by arranging the inlet-side opening 34 to fully communicate with the heated air passage 32 while the foot opening 37 is fully opened by arranging the outlet-side opening 35 to fully communicate with the foot opening 37. At this time, the cooled air bypass passage 29 and the face opening 36 are closed by the partition wall 42b and the partition wall 42a, respectively. Therefore, the full amount of the heated air from the passage 32 is blown out through the foot opening 37.

The position shown in FIG. 3D means that the inlet-side opening 34 widely opens the heated air passage 32 and partially opens the cooled air bypass passage 29. The outlet-side opening 35 widely opens the foot opening 37 while the face opening 36 is closed by the partition wall 42a. Therefore, a little bit amount of the cooled air from the bypass passage 29 is mixed with the heated air from the passage 32 to produce the mixed air having the temperature slightly lower than that of the heated air from the passage 32. The mixed air is blown out through the foot opening 37.

(4) Shut Mode

When a shut mode or a defroster mode is selected based on a signal from the rear seat blow-out mode setting device (not shown) or based on the calculation result of the blow-out mode in the ECU, the rotary door 33 takes its position shown in FIG. 3F. In this position, the face opening 36 and the foot opening 37 are simultaneously closed by the partition wall 42a. Therefore, the air cannot be blown out through the openings 36 and 37. This operation to prevent the air blown out through the both openings 36 and 37 can also be conducted by shutting the cooled air bypass passage 29 and the heated air passage 32 with the partition wall 42a.

The shut mode is useful because the conditioned air is not supplied to the rear-seat side but to the inside plane of the windshield of the vehicle to enhance an ability to prevent a windshield from being fogged when the defroster mode is selected. Also, it is useful when nobody is in the rear-seat side of the vehicle or a passenger in the rear seat does not want to have the air blown from blow-out ports connected to the face opening 36 and the foot opening 37, respectively.

In this embodiment, the area ratio(s) for communication between one of the openings 34 and 35, i.e., the inlet-side opening 34 and the cooled air bypass passage 29, the heated air passage 32, or both the bypass passage 29 and passage 32 at the same time can change by rotating the rotary door 33. Therefore, the rotary door 33 serves as the air-mix door.

While, the area ratio(s) for communication between one of the openings 34 and 35, i.e., the outlet-side opening 35 and the face opening 36, the foot opening 37, or both the face opening 36 and foot opening 37 at the same time can change also. Therefore, the rotary door 33 serves as the mode switching door. Furthermore, the conditioned air is prevented from being blown out through the face opening 36 and foot opening 37 by arranging the partition wall 42a to meet the openings 36 and 37 by rotation.

As described above, the rotary door 33 has the inlet-side opening 34 and the outlet-side opening 35 so that the air can flow into the inside of the door 33 and the conditioned air can smoothly flow out from the inside the door 33. Accordingly, it is possible not to cause the problem that the blow-out loss is large because of the interference which may occur between the air coming into the inside of the rotary door and the air blown out from the inside the rotary door.

Moreover, the face opening 36 and the foot opening 37 can be simultaneously closed by using the partition wall between the openings 34 and 35. Consequently, it is realized that the air mix and the mode switching can be performed with one rotary door 33 with the blow-out loss being reduced while a condition where the plural openings, i.e., the openings 36 and 37 in this embodiment can be closed is able to be performed (shut mode).

The partition walls 42a and 42b have the resin film, the resin sheet or the metal sheet. These materials have self-sealing characteristic with the openings 29, 32, 36 and 37 of the case 11. Therefore, it is not necessary to provide a sealing member such as a packing.

The cooled air bypass passage 29 and the heated air passage 32 at an upstream side of the intersection part 30 can be closed off with the partition wall 42a. Alternatively, the face opening 36 and the foot opening 37 can be closed off with the partition wall 42a. That is because the inlet side of the air and the outlet side of the air in the rotary door 33 are distinct from each other so that the air is prevented from being blown out through the face opening 36 and the foot opening 37 by closing one of the inlet side and the outlet side of the intersection part 30 with the partition wall 42a.

The face opening 36 and the foot opening 37 are adjacently arranged with one another along a direction of the circumference of the rotary door 33. In the bi-level mode in which the air is blown out through both the openings 36 and 37, the temperature of the air flowing through the opening 36 is equal to that of the air flowing through the opening 37 because the inside the rotary door 33 becomes the air mix chamber. Moreover, this arrangement is effective in a case where space cannot be acquired because of the arrangement of ducts in the vehicle or other reasons.

(Second Embodiment)

A second embodiment of the present invention will be described with reference to FIG. 4. The structure of a rotary door 33 is different from that of the rotary door described in the first embodiment. A frame body or partition wall 38 of the door 33 can be made of the resin member or the metal member. Further, a packing 40 is attached to an outer surface of the partition wall 38 as a seal member to prevent the openings 34 and 35 and the blow-out openings 36 and 37 from communicating with each other. It is also applicable to provide a seal member such as a packing member to the rotary door or the case 11, provided that the rotary door is made from the resin molding or the metal member.

(Third Embodiment)

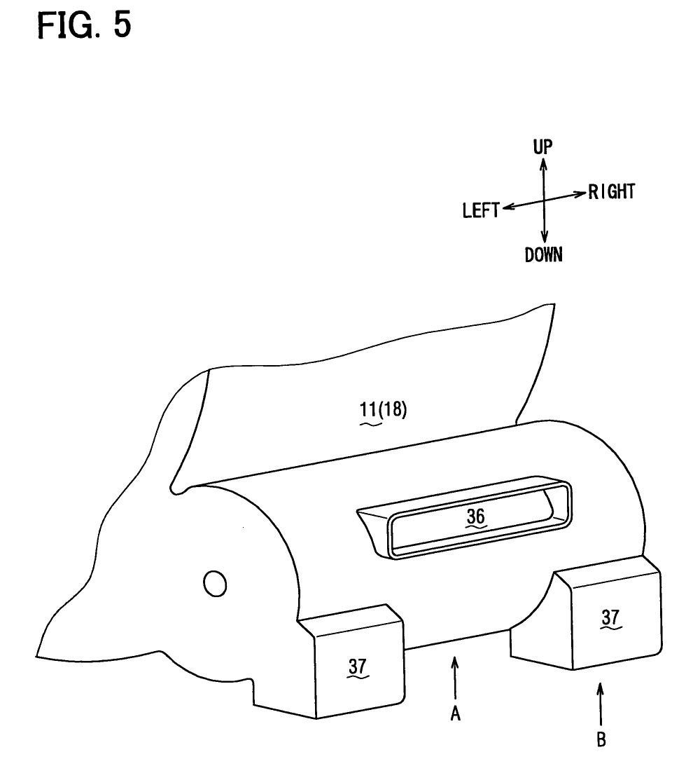

In the first or second embodiment, the face opening 36 and the foot opening 37 are adjacently arranged with one another along a direction of the circumference of the rotary door 33. To the contrary, in this embodiment, a face opening 36 is arranged in a center of a rotary door 33 in a direction along a central axis thereof (a lateral direction of the vehicle) as shown in FIG. 5. Foot openings 37 are arranged at both sides of the face opening 36 in the central axis direction, respectively, as shown in FIG. 5. That is, the foot openings 37 are arranged in end portions of the rotary door 33 in the central axis direction thereof in this embodiment. With this feature, a configuration including the openings 36 and 37 can be flattened as a whole. Accordingly, this configuration is practical in a case where enough space can be acquired in the up-down (vertical) direction because of the arrangement of ducts.

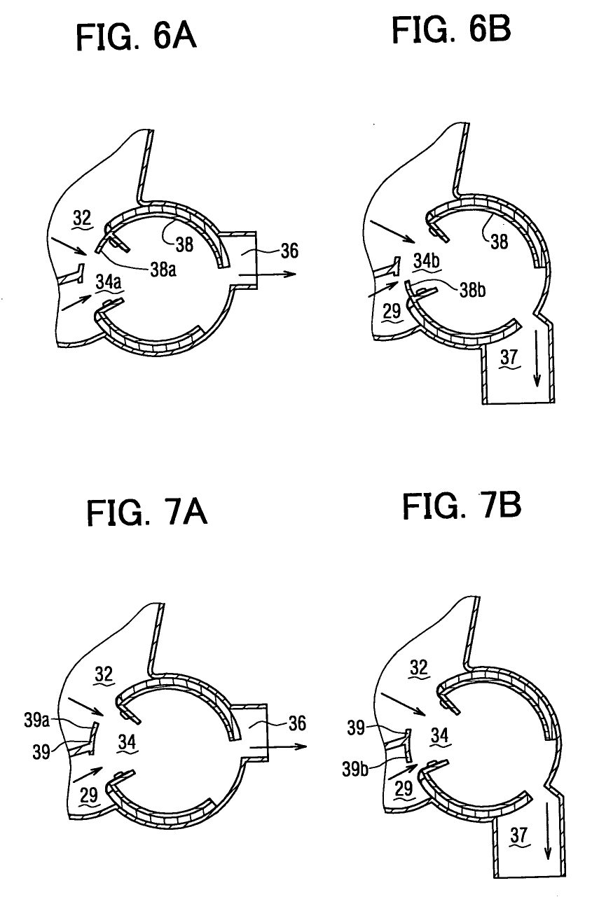

Referring to FIG. 5 and FIG. 6A showing a cross section at A in FIG. 5, a rib 38a protrudes from a frame body 38 to decrease an opening area of a heated air passage 32 at a first inlet opening 34a opposed to the face opening 36. Referring to FIG. 5 and FIG. 6B showing a cross section at B in FIG. 5, a rib 38b protrudes from the frame body 38 to decrease an opening area of a cooled air bypass passage 29 at a second inlet opening 34b opposed to the foot opening 37.

As described above, the first inlet opening 34a opposed to the face opening 36 is shifted along a direction in the circumference of the rotary door 33 with respect to the second inlet opening 34b opposed to the foot opening 37. With this configuration, an air mix chamber of the rotary door can provide a condition in which the temperature of the air flowing through the face opening 36 is different from that of the air flowing through the foot opening 37.

In the bi-level mode in the above described embodiment where the openings 36 and 37 are adjacently arranged in the circumference direction of the rotary door 33, the temperature of the air flowing through the opening 36 is equal to that of the air flowing through the opening 37. However, in this embodiment, a condition where the relatively cooled air can be provided at the upper body portion of the rear seated passenger while the relatively heated air can be provided at the foot portion of the rear seated passenger is able to be realized as shown by the two two-dotted lines in FIG. 3G.

(Fourth Embodiment)

This embodiment is a modification of the third embodiment described above. In the third embodiment, the ribs 38a and 38b are provided at opening ends of the first and second inlet openings 34a and 34b, respectively, so that the openings are shifted with respect to one another. In this embodiment, ribs 39a and 39b are provided at end portions of a partition member 39, respectively as shown in FIGS. 7A and 7B, so that the ratio between the area communicating between a heated passage 32 and an inlet opening 34 and the area communicating between a cooled air bypass passage 29 and the inlet opening 34 at a portion where the rib 39a is provided, is different from that between the area communicating between the heated passage 32 and the inlet opening 34 and the area communicating between the cooled air bypass passage 29 and the inlet opening 34 at a portion where the rib 39b is provided to supply the air having different temperatures to the different blow-out openings, respectively.

Referring to FIG. 7A which shows a cross section of a portion with an arrow A shown in FIG. 5, the rib 39a is formed at a portion of the partition member 39 between the heated air passage 32 and the cooled air bypass passage 29, which is opposed to the face opening 36, to reduce an opening area of the heated air passage 32. On the other hand, referring to FIG. 7B which shows a cross section of a portion with an arrow B shown in FIG. 5, the rib 39b is formed at a portion of the partition member 39, which is opposed to the foot opening 37, to reduce an opening area of the cooled air bypass passage 29.

Like the third embodiment described above, the condition where the relatively cooled air can be provided at the upper body portion of the rear seated passenger while the relatively heated air can be provided at the foot portion of the rear seated passenger is able to be realized in the bi-level mode as shown by the two two-dotted lines in FIG. 3G.

Although the present invention is embodied to the above-mentioned apparatus, the present invention can be adapted to an air conditioning apparatus in which the conditioned air is only supplied to a front seat or only to a rear seat. Although the communication between the cooled air passage 29 and/or the heated air passage 32 and the face and/or the foot openings 36, 37 is achieved by using a circumference plane of the cylindrical shape of the rotary door 33, the communication can be obtained by using both end portions of the cylindrical shape of the rotary door 33. Although the sealing member such as the packing 40 is attached to the partition wall (frame body) 38 in the second embodiment, the sealing member can be attached to the periphery of each of the cooled, heated air passage 29 and 32, and the blow-out openings 36 and 37.

While the present invention has been shown and described with reference to the foregoing preferred embodiment, it will be apparent to those skilled in the art that changes in form and detail may be therein without departing from the scope of the invention as defined in the appended claims.

What is claimed is:

1. A vehicle air conditioner comprising:
a cooling heat exchanger for cooling air;
a heating heat exchanger for heating air;
a cooled air passage through which cooled air cooled by the cooling heat exchanger flows;
a heated air passage through which heated air heated by the heating heat exchanger flows;
an intersecting portion to which the cooled air passage and the heated air passage are connected;
a cylindrical rotary door provided at the intersecting portion having a plurality of openings and partition walls at its periphery; and
a plurality of blow-out openings provided at a downstream side with respect to the intersecting portion for blowing the conditioned air to a passenger compartment of the vehicle, wherein:
a communicating area ratio between an inlet-side opening among the plurality of openings and at least one of the cooled air passage and the heated air passage changes by a rotation of the rotary door so that the rotary door serves as an air mixing device, while a communicating area ratio between an outlet-side opening among the plurality of openings and at least one of the blow-out openings so that the rotary door serves as a mode switching door at the same time;
the rotary door has a rotated position where the conditioned air is prevented from being blown out through the plurality of blow-out openings by the partition wall; and
the plurality of blow-out openings includes a face opening and a foot opening.

2. A vehicle air conditioner according to claim 1, wherein:
said partition wall of the rotary door has at least one of a resin film-like member, a thin plate resin member and a thin plate metal member.

3. A vehicle air conditioner according to claim 1, wherein:
said rotary door is made of a resin material or a metal material, and said rotary door has a sealing member to prevent the plurality of openings from communicating with the plurality of blow-out openings.

4. A vehicle air conditioner according to claim 1, wherein:
said rotary door has a position where the partition wall shuts both the cooled air passage and the heated air passage provided at an upstream side of the intersecting portion.

5. A vehicle air conditioner according to claim 1, wherein:
said rotary door has a position where the partition wall shuts the plurality of blow-out openings provided at the downstream side of the intersecting portion.

6. A vehicle air conditioner according to claim 1, wherein:
said plurality of blown-out openings includes a rear seat face opening for blowing the conditioned air toward an upper body of a passenger seated in a rear seat, and a rear seat foot opening for blowing the conditioned air toward a foot portion of the passenger seated in the rear seat.

7. A vehicle air conditioner according to claim 6, wherein:
the face opening is arranged adjacent the foot opening in a circumferential direction of the cylindrical rotary door.

8. A vehicle air conditioner according to claim 6, wherein:
the face opening and the foot opening are arranged in a direction parallel to a central axis of the cylindrical rotary door so that the face opening and the foot opening are arranged at different positions along the central axis, respectively.

9. A vehicle air conditioner according to claim 8, wherein:
a rib is provided at an end of the inlet-side opening opposed to the rear seat face opening to reduce a communicating area defined by the inlet-side opening with said rib and an open end of the heated air passage.

10. A vehicle air conditioner according to claim 8, wherein:
a rib is provided at an end of the inlet-side opening opposed to the rear seat foot opening to reduce a communicating area defined by the inlet-side opening with said rib and an open end of the cooled air passage.

11. A vehicle air conditioner according to claim 8, wherein:
a rib is provided at a partitioning portion formed between the cooled air passage opposed to the rear seat face opening and the heated air passage opposed to the rear seat face opening, and the rib reduces a communicating area between the inlet-side opening and the heated air passage.

12. A vehicle air conditioner according to claim 8, wherein:
a rib is provided at a partitioning portion formed between the cooled air passage opposed to the rear seat foot opening and the heated air passage opposed to the rear seat foot opening, and the rib reduces a communicating area between the inlet-side opening and the cooled air passage.

13. A vehicle air conditioner according to claim 1, wherein:
said partitioning portion includes a longer arc defined with one end of the inlet-side opening and one end of the outlet-side opening, and a shorter arc defined with the other end of the inlet-side opening and the other end of the outlet-side opening, wherein:
the rotary door has a position where said longer arc simultaneously closes both of the cooled air passage and heated air passage or both of the face opening and foot opening.
